(19) United States
(12) Patent Application Publication
(10) Pub. No.: US 2006/0145966 A1
(43) Pub. Date: Jul. 6, 2006

(54) Driving device for light-emitting display panel

(75) Inventor: Shinobu Adachi, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/318,531

(22) Filed: Dec. 28, 2005

(30) Foreign Application Priority Data
Jan. 6, 2005 (JP) 2005-001683

(51) Int. Cl. G09G 3/30

(52) U.S. Cl. 345/76

(57) ABSTRACT

There is provided a drive device for a light-emitting display panel which can reduce shadowing caused by an ON rate of light-emitting elements and a condition of dimmer setting to a level at which a problem is not posed. An analog video signal is supplied to a drive control circuit and an A/D converting circuit, and the analog video signal is converted into image data corresponding to each pixel in the A/D converting circuit. The image data is written in an image memory. The image data is read from the image memory every scanning operation, and the drive control circuit acquires a rate (ON rate of light-emitting elements in each scanning operation) of EL elements to be controlled to emit light. ON-drive data is read from a look-up table on the basis of the ON rate of the dimmer setting data. On the basis of the ON drive data, a drive current of a light-emitting element to be turned on is determined. Depending on ON-drive data corresponding to the ON rate and the dimmer setting, a light-emitting luminance of the light-emitting element is corrected, so that shadowing can be effectively suppressed from occurring.

### BACKGROUND OF THE INVENTION

1. Field of the Invention

The present invention relates to a drive device which can be preferably applied to a passive matrix light-emitting display panel using a capacitive light-emitting element and, more particularly, to a drive device for a light-emitting display panel which can reduce degrees of generation of shadowing (horizontal crosstalk) caused by a change in ON rate of the light-emitting element to a level at which a practical problem is not posed.

2. Description of the Related Art

Along with the popularization of a mobile telephone, a personal digital assistant (PDA), and the like, a demand for a display panel which has a high definition image display function and which can realize a small thickness or a low power consumption increases. As a display panel which satisfies the demand, conventional liquid crystal panels are applied to a large number of products. On the other hand, in recent years, an organic EL (Electro-Luminescence) element which takes advantage of characteristics of a self light-emitting element is practically used. The display panel draws attention as a next-generation display panel which is replaced with a conventional liquid crystal display panel. This is caused by a background in which an organic compound which can expect preferable light-emitting characteristics is used in a light-emitting layer of an element to achieve practical high efficiency and practical long life.

The organic EL element, for example, is basically formed such that a transparent electrode (anode) consisting of, e.g., ITO, a light-emitting function layer, and a metal electrode (cathode) consisting of an aluminum alloy or the like are sequentially stacked on a transparent substrate such as a glass substrate. The light-emitting function layer may be a single light-emitting layer consisting of an organic compound, a two-layer structure consisting of an organic hole transportation layer and a light-emitting layer, a three-layer structure consisting of an organic hole transportation layer, a light-emitting layer, and an organic electron transportation layer, or a multi-layer structure obtained by inserting a hole-implanted layer between the transparent electrode and the hole transportation layer or inserting an electron-implanted layer between the metal electrode and the electron transportation layer. Light emitted from the light-emitting function layer is guided outside through the transparent electrode and the transparent substrate.

The organic EL element can be electrically replaced with a configuration constituted by a light-emitting element having diode characteristics and a parasitic capacitive component coupled in parallel to the light-emitting element. It can be said that the organic EL element is a capacitive light-emitting element. When a light-emitting drive voltage is applied to the organic EL element, first, electric charges corresponding to the electric capacitance of the element flow into the electrode as a displacement current and are accumulated in the electrode. Subsequently, when the voltage exceeds a predetermined voltage (light-emitting threshold voltage=Vth) inherent in the element, a current begins to flow from one electrode (anode side of the diode component) to the light-emitting function layer. It can be understood that light emission occurs with an intensity which is in proportion to the current.

On the other hand, the organic EL element has a current-luminance characteristic which is stable to a change in temperature, and has a voltage-luminance characteristic which is highly dependent on the change in temperature. The organic EL element is considerably deteriorated when an overcurrent flows in the organic EL element, and has reduced emission lifetime. For this reason, the organic EL element is generally driven by a constant current. As a display panel using the organic EL element, a passive drive display panel in which elements are arranged in the form of a matrix has been practically used in part.

FIG. 1 shows a conventional passive matrix display panel and an example of a drive circuit therefor. The drive circuit has an aspect of cathode-line scanning/anode-line drive. That is, m data lines (to be also referred to as a node lines hereinafter) A1 to Am are vertically arranged, and n scan lines (to be also referred to as cathode lines hereinafter) K1 to Kn are horizontally arranged, and organic EL elements E11 to Emn indicated by parallel couplings between the symbol marks of diodes and capacitors are arranged at cross points (total of m×n points) of the data lines and the scan lines, so that a display panel 1 is constituted.

In the organic EL elements E11 to Emn constituting pixels, one terminals (anode terminals of equivalent diodes of the EL elements) are connected to the anode lines, and the other terminals (cathode terminals of equivalent diodes of the EL elements) are connected to the cathode lines with respect to the cross points of the vertical anode lines A1 to Am and the horizontal cathode lines K1 to Kn. Furthermore, the anode lines A1 to Am are connected to an anode line drive circuit 2 serving as a data drive, and the scan lines K1 to Kn are connected to a cathode line scanning circuit 3 serving as a scanning driver to drive the anode lines A1 to Am and the scan lines K1 to Kn.

The anode line drive circuit 2 includes constant current sources I1 to Im serving as ON-drive voltage sources operated by using a drive voltage from a drive voltage source VH and drive switches Sa1 to Sam serving as switching means. The drive switches Sa1 to Sam are connected to sides of the constant current sources I1 to Im to supply currents from the constant current sources I1 to Im to the respective organic EL elements E11 to Emn arranged with respect to the cathode lines. The drive switches Sa1 to Sam are designed such that a voltage from a voltage source VAM or a reference voltage point (ground potential GND in this embodiment) serving as an OFF-drive voltage source can be supplied to the respective EL elements E11 to Emn arranged with respect to the cathode lines.

On the other hand, the cathode line scanning circuit 3 includes scan switches Sk1 to Skn serving as switching means are arranged with respect to the cathode lines K1 to Kn. The cathode line scanning circuit 3 is designed such that any one of a reverse bias voltage from a reverse bias voltage source VM mainly used to prevent crosstalk emission or the ground potential GND serving as a reference voltage point can be supplied to a corresponding cathode line.

Control signals are supplied from a light-emission control circuit 4 including a CPU or the like to the anode line drive circuit 2 and the cathode line scanning circuit 3 through a control bus, respectively. On the basis of a video signal to be displayed, switching operations for the scan switches Sk1 to Skn and the drive switches Sa1 to Sam are performed. In this manner, the constant current sources I1 to Im are connected to desired anode lines while setting the cathode lines at the ground voltage in a predetermined cycle on the basis of the video signal to cause the

organic EL elements E11 to Emn to emit light, so that an image based on the video signal is displayed on the display panel 1.

In the state shown in FIG. 1, the second cathode line K2 is set to the ground voltage to set a scanning state. At this time, reverse bias voltages from the reverse bias voltage source VM are applied to the respective cathode lines K1 and K3 to Kn in a non-scanning state. In this case, when the forward voltage of the EL element in the scanning light-emitting state is represented by Vf, the voltages are set to satisfy a relationship given by: [(forward voltage Vf)−(reverse bias voltage VM)]<(light-emitting threshold voltage Vth). Therefore, the drive device operates such that EL elements connected to cross points of driven anode lines and cathode lines which are not selected as scan lines are prevented from performing crosstalk light emission.

The respective organic EL elements arranged on the display panel 1 have parasitic capacitances, respectively as mentioned above. Since the organic EL elements are arranged in the form of a matrix at the cross points of the anode lines and the cathode lines, in an example in which several ten EL elements are connected to one anode line, a synthetic capacity which is equal to or larger than a capacity several hundred times each parasitic capacity when viewed from the anode line is connected to the anode line as a load capacity. The synthetic capacity conspicuously increases as the size of the matrix increases.

Therefore, at the beginning of an ON scanning period of the EL elements, the currents from the constant current sources I1 to Im through the anode

lines are consumed to charge the synthetic capacity, time delay occurs to charge the load capacity until the load capacity sufficiently exceeds a light-emitting threshold voltage (Vth) of the EL elements. Therefore, rising of light emission of the EL elements is disadvantageously delayed (slowed). In particular, as described above, when the constant current sources I1 to Im are used as drive sources of the EL elements, the currents are restricted because the constant current sources are high-impedance output circuits on an operational principle, so that the rising of light emission of the EL elements is considerably delayed.

This decreases ON-time rates of the EL elements. Therefore, the substantial light-emitting luminances of the EL elements disadvantageously decrease. For this reason, in order to eliminate the delay of rising of light emission of the EL elements caused by the parasitic capacities, in the configuration shown in FIG. 1, an operation of charging EL elements to be turned on is performed by using the reverse bias voltage source VM.

FIGS. 2A to 2E show an ON-drive operation of EL elements including a reset period in which amounts of charge accumulated in the parasitic capacities of the EL elements to be turned on are zero. FIG. 2A shows a scanning synchronous signal. In this example, in synchronism with the scanning synchronous signal, a reset period and a constant current drive period are set.

FIGS. 2B and 2C show voltages applied to an ON line and an OFF line of the anode lines connected to the anode driver (anode line drive circuit) 2 in the respective periods. FIGS. 2D and 2E show voltages applied to a scan line and a non-scan line of the cathode lines connected to the cathode driver (cathode line scanning circuit) 3 in the respective periods.

In the reset period shown in FIGS. 3A to 3E, the drive switches Sa1 to Sam serving as switching means included in the anode driver 2 supply voltages from the voltage source VAM to the anode line (ON line) corresponding to the EL elements to be ON-controlled as shown in FIG. 2B. The circuit is controlled such that a ground potential GND serving as a reference voltage of the circuit is supplied to the anode line (OFF line) corresponding to the EL elements to be turned off as shown in FIG. 2C.

On the other hand, the cathode scanning driver 3 is designed to apply reverse bias voltages VM to cathode lines (scan lines) to be scanned and cathode lines (non-scan lines) not to be scanned by the scan switches Sk1 to Skn serving as switching means included in the cathode driver 3 as shown in FIGS. 2D and 2E.

In the constant current drive period which is an ON period of the EL element, the drive switches Sa1 to Sam supply constant currents from the constant current sources I1 to Im to anode lines (ON lines) corresponding to EL elements to be turned on as shown in FIG. 2B. The ground potential GND serving as a reference voltage of the circuit is set to anode lines (OFF lines) corresponding to EL elements to be turned off as shown in FIG. 2C.

On the other hand, the cathode driver 3 in the constant current drive period is controlled such that the scan switches Sk1 to Skn included therein set cathode lines (scan lines) to be scanned to the ground potential GND as shown in FIG. 2D and apply the reverse bias voltage VM to the cathode lines (non-scan lines) not to be scanned as shown in FIG. 2E.

Immediately after the shift to the constant current drive period, amounts of charges on the parasitic capacities of all the EL elements connected to the ON lines are zero. For this reason, currents transiently flow from the reverse bias voltage source VM into the EL elements to be turned on through EL elements which are not scanned, and the parasitic capacities of the EL elements to be turned on are rapidly charged. As a result, light emission of the EL elements to be turned on relatively quickly rise.

As described above, the passive drive display device which precharges EL elements to be ON-driven by using a reverse bias voltage is disclosed in the Japanese Patent Laid-Open Application No. 9-232074 or the like.

In the passive drive display device having the above configuration, it is known that so-called shadowing (horizontal crosstalk) in which light-emitting luminances of the EL elements corresponding to scan lines having different ON rates fluctuate depending on the ON rates of the EL elements occurs. FIGS. 3A and 3B and FIGS. 4A and 4B explain a state in which the shadowing occurs.

FIGS. 3A and 3B show a voltage application state to the EL elements in the reset period according to the timing chart shown in FIGS. 2A to 2E and a voltage application state to the EL elements in the constant current drive period according to the timing chart shown in FIGS. 2A to 2E. In FIGS. 3A and 3B, a case in which the ON rate of the EL element is 100%. FIGS. 3A and 3B, for descriptive convenience, show supply states of voltages to the EL elements corresponding to the first, second, and mth anode lines and the first, second, and nth cathode lines.

As shown in FIG. 3A, in the reset period, all the scan switches Sk1 to Skn are connected to the VM side, and a reverse bias voltage VM is applied to the scan lines K1 to Kn. All the drive switches Sa1 to Sam are connected to the VAM side. In this case, the reverse bias voltage VM and the voltage source VAM satisfy a relationship given by: VM=VAM. Therefore, in the reset period shown in FIG. 3A, a voltage difference between both the ends of each of all the EL elements is eliminated, and an amount of charge accumulated in the parasitic capacity of the EL element becomes zero.

On the other hand, in the constant current drive period, as shown in FIG. 3B, a first scan line K1 to be turned on for scanning is set to the ground potential GND through the scan switch Sk1, and the reverse bias voltage VM is continuously applied to the other scan lines through the scan switches Sk2 to Skn. At this time, all the drive switches Sa1 to Sam are connected to sides of the constant current sources I1 to Im, respectively.

In this manner, ON-drive currents from the constant current sources I1 to Im are supplied to the EL elements connected to the first scan line K1. At this time, a current flowing from the reverse bias voltage VM to the parasitic capacities of the EL elements transiently flows into the anode side of the EL elements to be turned on through the respective anode lines, and the parasitic capacities of the EL elements to be turned on are rapidly charged. As a result, rising of light emission of the EL elements to be turned on is relatively quickly performed.

FIGS. 4A and 4B show an operation performed when an ON rate of the EL elements decreases. FIGS. 4A and 4B show supply states of potential to the EL elements in the reset period and the constant current drive period as in FIGS. 3A and 3B. However, in the example shown in FIGS. 4A and 4B, the EL elements corresponding to the first and second anode lines are turned off, and the EL elements corresponding to the mth anode line are turned on. Therefore, it can be said that the ON rate of the EL element is 33% in the scope shown in FIGS. 4A and 4B.

In the reset period, as shown in FIG. 4A, the reverse bias voltage VM is applied to the scan lines K1 to Kn. The first and second anode lines A1 and A2 are connected to the ground potential GND, and the mth anode line Am is connected to the VAM side. Whereby, a voltage difference between both the ends of each of the EL elements connected to the mth anode line Am is eliminated, and an amount of charge accumulated in the parasitic capacities of the EL elements connected to the mth anode line Am becomes zero. On the other hand, a reverse bias voltage obtained by the reverse bias voltage VM is applied to the EL elements connected to the first and second anode lines A1 and A2 controlled to be in an OFF state and charged with the polarity shown in FIG. 4A.

Subsequently, in the constant current drive period, as shown in FIG. 4B, for example, the first scan line K1 to be turned on for scanning is set to the ground potential GND, and the reverse bias voltage VM is applied to the other scan lines. At this time, the first and second anode lines A1 and A2 controlled to be in an OFF state are set to the ground potential GND, and the mth anode line Am controlled to be in an ON state is connected to the constant current source Im side.

In this manner, an ON-drive current from the constant current source Im is supplied to the EL elements to be turned on connected to the first scan line K1 and the mth anode line Am. At this time, a current flowing from the reverse bias voltage VM into the parasitic capacities of the EL elements which are not scanned transiently flows into the anode side of the EL elements to be turned on through the anode lines to rapidly charge the parasitic capacities of the EL elements to be turned on. As a result, rising of light emission of the EL elements to be turned on is relatively quickly performed.

In this case, the EL elements not to be turned on have been charged by the reverse bias generated by the reverse bias voltage VM and are not changed in state. For this reason, a transient current from the reverse bias VM through the anode lines A1 and A2 not to be turned on rarely flow into the EL elements. As a result, the reverse bias voltages in the cathode lines K2 to Kn in a non-scanning state are rarely dropped, and a current transiently flowing into the anode side of the EL elements to be turned on for scanning through the cathode lines K2 to Kn in a non-scanning state and the anode line Am to be turned on is larger than that in the state shown in FIG. 3B. In this manner, the degree of rising of luminance at the beginning of light emission of the EL elements to be turned on for scanning is conspicuous more than that in the example shown in FIGS. 3A to 3E.

FIG. 5 typically showing an example of shadowing (horizontal crosstalk) caused by the operation described above. In the display pattern shown in FIG. 5, a double-hatched portion “A” indicates a region in which EL elements are set in an OFF state, and single-hatched portions “B” and “C” indicate regions in which EL elements are in an ON state. As indicated as “A” in FIG. 5, for each scan line, when a rate of OFF elements is high (ON rate is low), “bright horizontal crosstalk” in which the portion indicated by “B” emits light brightly more than the portion indicated by “C” occurs.

The example described above is based on a VM reset method which applies a reverse bias voltage of the reverse bias voltage VM to the EL element controlled to be in an OFF state. In contrast to this, in the reset operation mode, in a GND reset method which sets both the ends of EL element controlled in an OFF state at the ground potential GND, it is known that “dark horizontal crosstalk” in which the portion indicated by “B” in FIG. 5 emits light brightly more than the portion indicated by “C” occurs. In addition, the shadowing occurs in various aspects by factors such as a display pattern of the display panel and a time constant.

On the other hand, it is known that, as a dimmer value on a dimmer display which controls the entire brightness of the display panel decreases, the degree of occurrence of the shadowing becomes conspicuous. This phenomenon occurs for the following reason. That is, it is considered that, as the dimmer value is set at a low level, contribution of electric charges flowing through the EL element scanned through a parasitic capacity of an EL element which is not scanned becomes relatively high because light-emission time of the EL element in one scanning period is short or the value of a drive current is small.

### SUMMARY OF THE INVENTION

The present invention has been made in consideration of the problems described above, and has as its object to provide a drive device and a drive method for a light-emitting display panel which can reduce shadowing occurring when an ON rate of EL elements is low and more prominently occurring as setting of a dimmer value becomes lower by a dimmer control as described above to a level at which any problem does not occur in practice.

In a preferable basic aspect of the drive device according to the present invention made to solve the above problem, there is provided a drive device to drive a passive matrix light-emitting display panel having a plurality of scan lines and a plurality of data lines which cross each other, and light-emitting elements connected between the scan lines and the data lines at crossing points of the scan lines and the data lines to emit light, including an ON rate acquiring unit which obtains a rate PN of light-emitting elements to be controlled to emit light in the light-emitting elements connected to the scan lines N (N=1 to n), and wherein, on the basis of the rate PN obtained by the ON rate acquiring unit, a period for supplying a light-emitting drive current value and/or a light emitting drive current supplied to the light-emitting elements to be controlled to emit light, the light-emitting elements being connected to the scan lines N, is controlled.

### BRIEF DESCRIPTION OF THE DRAWINGS

FIG. 1 is a circuit diagram showing an example of a conventional passive matrix display panel and a drive circuit therefor;

FIGS. 2A to 2E are timing charts for explaining an ON-drive operation in the display panel shown in FIG. 1;

FIGS. 3A and 3B are circuit diagrams for explaining an operation performed when an ON rate of light-emitting elements is high according to the timing charts shown in FIGS. 2A to 2E;

FIGS. 4A and 4B are circuit diagrams for explaining an operation performed when the ON rate of the light-emitting elements is low according to the timing charts shown in FIGS. 2A to 2E;

FIG. 5 is a pattern diagram showing an example in which shadowing occurs;

FIG. 6 is a circuit diagram showing a first embodiment of the drive device according to the present invention;

FIGS. 7A to 7D2 are timing charts for explaining first and second ON-drive operations performed by the circuit configuration shown in FIG. 6;

FIG. 8 is a circuit diagram showing a second embodiment of the drive device according to the present invention;

FIGS. 9A to 9D are timing charts for explaining first and second ON-drive operations performed by the circuit configuration shown in FIG. 8;

FIGS. 10A to 10C2 are timing charts for explaining a third ON-drive operation performed by the circuit configuration shown in FIG. 8;

FIGS. 11A to 11C2 are timing charts for explaining a fourth ON-drive operation performed by the circuit configuration shown in FIG. 8; and

FIGS. 12A to 12C2 are timing charts for explaining a fifth ON-drive operation performed by the circuit configuration shown in FIG. 8.

### DESCRIPTION OF THE PREFERRED EMBODIMENTS

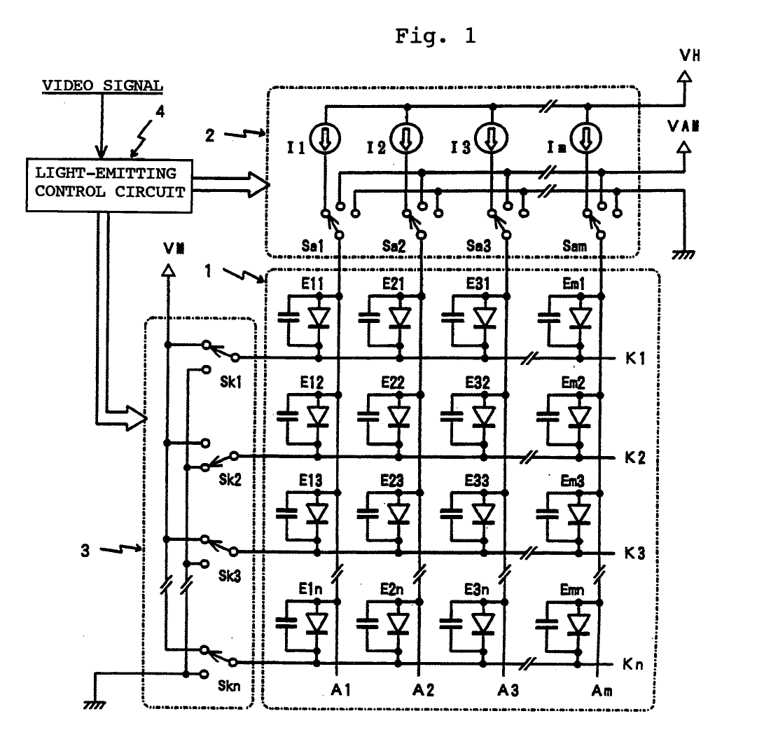

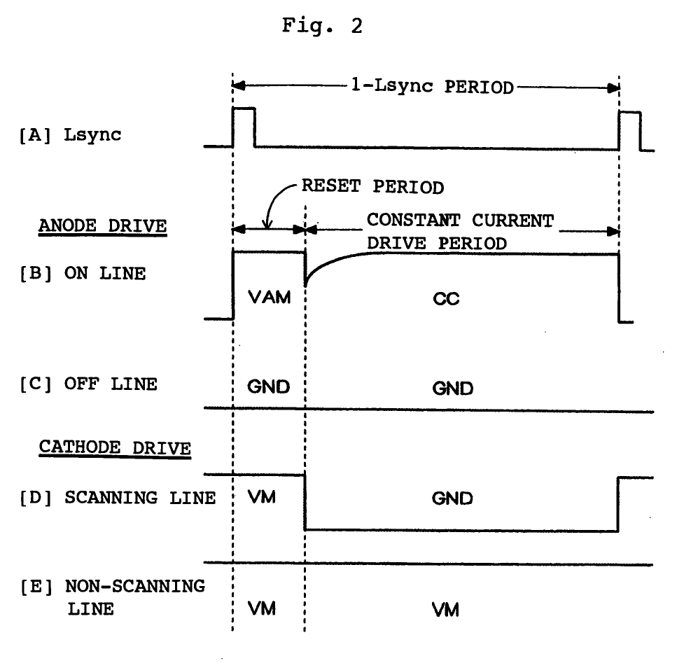

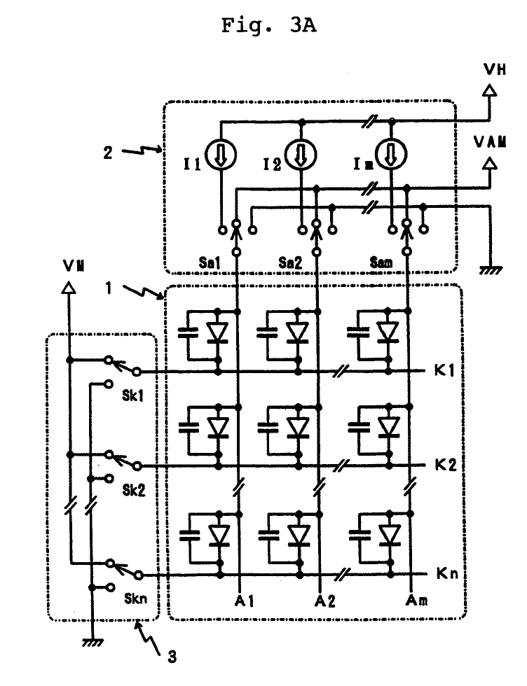

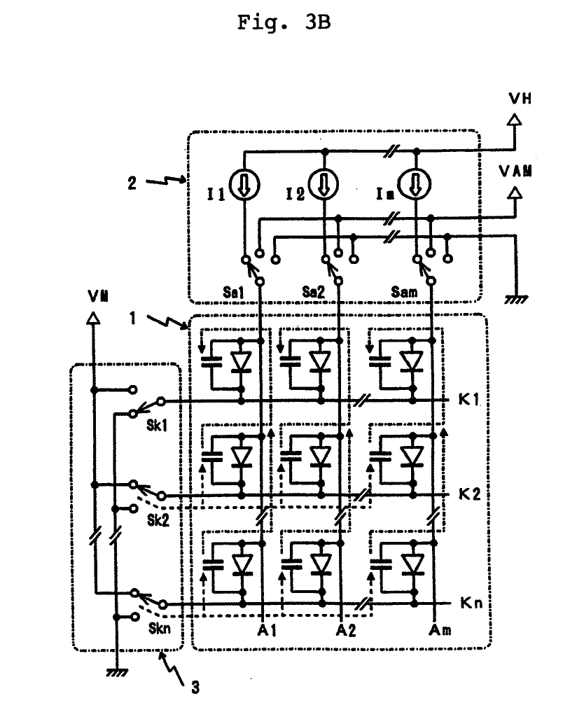

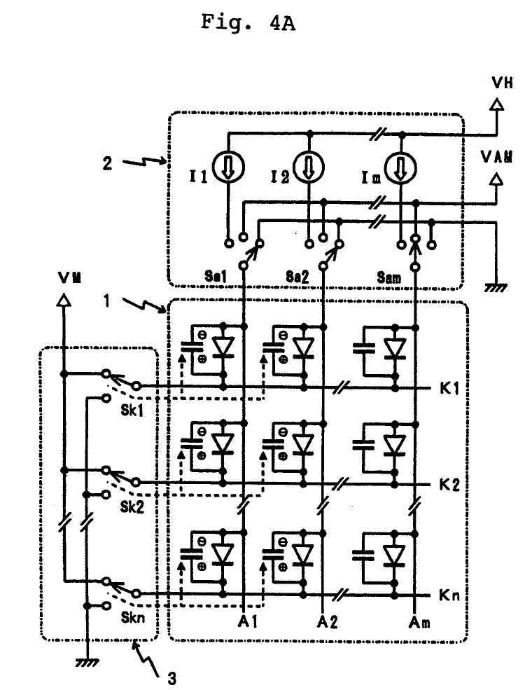

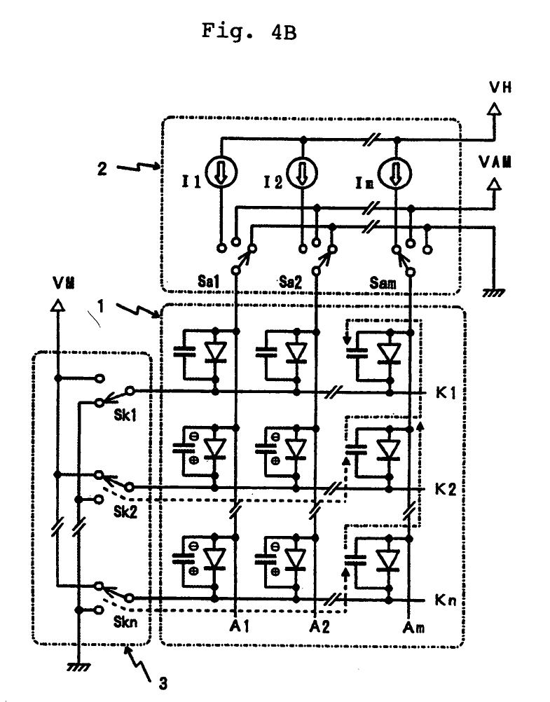

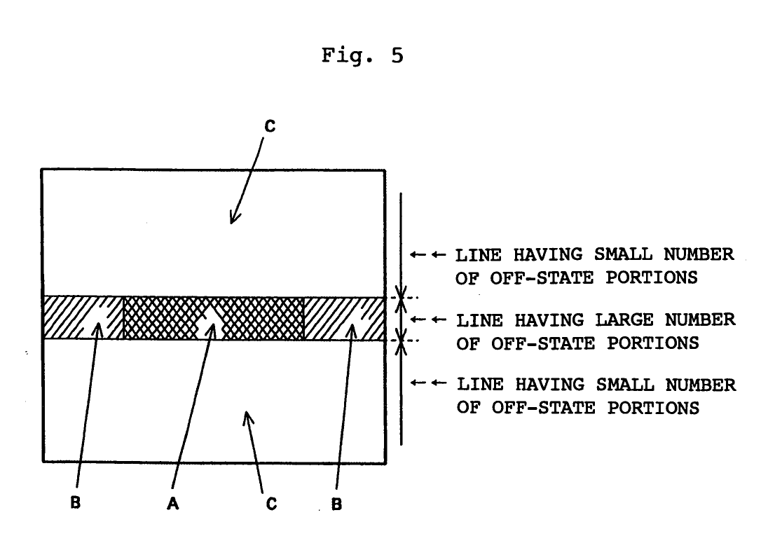

A drive device for a light-emitting display panel according to the present invention will be described below on the basis of embodiments shown in the drawings. The same circuit configuration as the configuration shown in FIG. 1 described above is employed, and a reset period and a constant current drive period (ON period) are set in synchronism with a scanning synchronous signal as shown in FIGS. 2A to 2E. In the embodiments described below, the same reference numerals denote parts having the same functions as those of the constituent elements shown in the drawings described above.

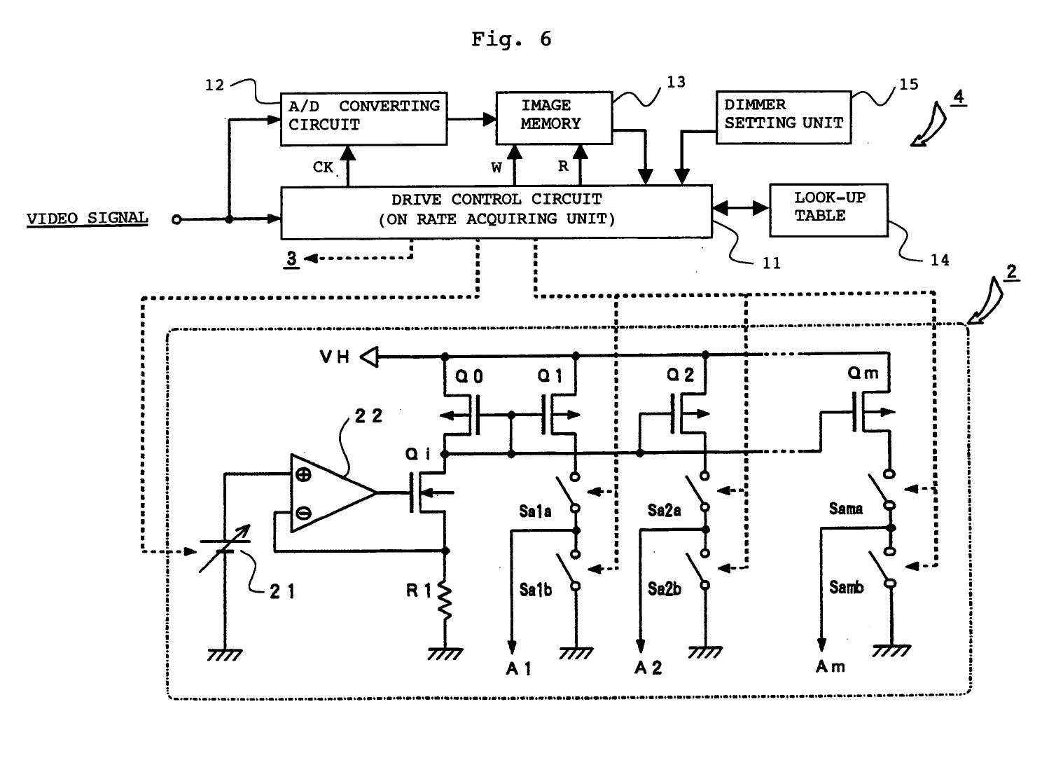

FIG. 6 shows the first embodiment to which the present invention is applied with respect to a part corresponding to, especially, a data driver 2 shown in FIG. 1 and a part corresponding to a light-emission control circuit 4. An analog video signal is supplied to the light-emission control circuit 4 shown in FIG. 6. The analog video signal is supplied to a drive control circuit 11 and an analog/digital (A/D) converting circuit 12 which constitute the light-emission control circuit 4.

The drive control circuit 11 generates a clock signal CK to the A/D converting circuit 12 and a write signal W and a read signal R to an image memory 13 on the basis of a horizontal sync signal and a vertical sync signal in the analog video signal. The drive control circuit 11 is designed to output a scan switching signal to a scanning driver 3 described with reference to FIG. 1 on the basis of the horizontal sync signal and the vertical sync signal.

The A/D converting circuit 12 operates to perform sampling of an input analog signal on the basis of a clock signal supplied from the drive control circuit 11 and to convert resultant signals into image data corresponding to respective pixels to supply the image data to the image memory 13. The image memory 13 operates to sequentially write the pixel data supplied from the A/D converting circuit 12 in the image memory 13 by the write signal W supplied from the drive control circuit 11.

When a frame memory is employed as the image memory 13, data of one screen (m columns and n rows) on a display panel 1 is written by the write operation. Upon completion of the writing operation of the data of one screen, image data is read every row (one scanning operation) from the first row to the nth row of a scan line by the read signal R supplied from the drive control circuit 11. The drive control circuit 11 operates to obtain a ratio (ON rate of EL elements of each scan line) PN of EL elements to be controlled to emit light. In other words, the drive control circuit 11 functions as an ON rate acquiring unit for EL elements.

On the other hand, in the configuration, dimmer control data is supplied from a dimmer setting unit 15 to the drive control circuit 11. In this manner, the display panel 1 is designed to perform dimmer display in D (D=1 to d) steps. Dimmer values may be manually set in the dimmer setting unit 15, or a dimmer value may also be automatically set in a mobile device or the like in response to external light.

The drive control circuit 11 operates to obtain ON-drive data corresponding to the ON rate PN as one form and to supply the ON-drive data obtained from the look-up table 14 to the data driver 2 indicated by a reference numeral 2 in FIG. 6. That is, in the configuration shown in FIG. 6, the ON rate PN is calculated for each scanning operation, and ON-drive data corresponding to the ON rate is supplied as a voltage value in a variable voltage source 21 which is equivalently shown.

The above operations are sequentially executed from the first row to the nth row (N=1 to n) of a scan line in synchronism with scanning of the scanning driver 3. In short, according to the above configuration, depending on an ON rate of EL elements in each scanning operation, the ON-drive data read from the look-up table 14 is supplied to the data driver 2.

The drive control circuit 11 operates to calculate ON-drive data as another form from the look-up table 14 by the ON rate PN and the data of the dimmer control to supply the ON-drive data obtained from the look-up table 14 to the data driver 2 indicated by reference numeral 2 in FIG. 6. According to this, depending on the ON rate of EL elements in each scanning operation and dimmer control data set at this time, the ON-drive data read from the look-up table 14 is supplied to the data driver 2. At this time, the look-up table 14 is structured in the form of a map (two-dimensional) from which ON-drive data can be extracted by the ON rate of EL elements and the dimmer control data.

As shown in FIG. 6, in the data driver 2, ON-drive data replaced by the variable voltage source 21 is designed to be supplied to the non-inverted input terminal of an operational amplifier 22 serving as a voltage value. The output terminal of the operational amplifier 22 is connected to the gate of a n-channel transistor Qi, and the drain of the n-channel transistor Qi is connected to the inverted input terminal of the operational amplifier 22 and connected to a ground GND through a resistor R1. That is, the operational amplifier 22 and the n-channel transistor Qi constitute a voltage/current converting unit and function such that an amount of current flowing in the transistor Qi is made variable depending on ON-drive data (voltage) replaced by the variable voltage source 21.

On the other hand, the source and the drain of a p-channel transistor Q0 are connected between a drive voltage source VH and the source of the transistor Qi. The gate and the drain of the transistor Q0 are short-circuited, the gates of P-channel transistors Q1 to Qm having sources connected to the drive voltage source VH are commonly connected to the gate of the transistor Q0.

In this manner, a current mirror circuit which uses the transistor Q0 as a controlling current source (reference current value) and transistors Q1 to Qm as controlled current sources is constituted. Therefore, the source current of the transistor Q0 functioning as the controlling current source is variably controlled by drive current data read from the look-up table 14, so that drain currents of the transistors Q1 to Qm are variably controlled by a current mirror operation.

The transistors Q1 to Qm functioning as the controlled current sources correspond to constant current sources I1 to Im shown in FIG. 1. One pair of analog switches functioning as drive switches are connected between the drains of the transistors Q1 to Qm and the ground GND, respectively, and ON/OFF-controlled by a command from the drive control means 11.

That is, analog switches Sa1a to Sama on the drain side of the transistors Q1 to Qm are turned on to supply a light-emitting drive current to drive lines (anode lines) A1 to Am corresponding to the analog switches Sa1a to Sama. Analog switches SA1b to Samb on the ground GND side are turned on to supply a ground GND potential serving as an OFF voltage to the anode lines A1 to Am corresponding to the analog switches SA1b to Samb.

As shown in FIG. 1, the drive switches Sa1 to Sam operate such that a voltage from a voltage source VAM is selected in, e.g., a reset period. For this reason, in FIG. 6, other analog switches are prepared for the transistors Q1 to Qm, respectively, and a description thereof will be omitted.

With the configuration shown in FIG. 6, an ON rate PN of EL elements every scanning operation is calculated. On the basis of the ON rate PN, ON-drive data is acquired from the look-up table 14 to control a value of a light-emitting drive current supplied to the EL elements. Therefore, a relationship between the ON rate PN and the ON-drive data corresponding thereto is stored in the look-up table 14 to make it possible to correct the light-emitting luminances of the EL elements depending on the ON rates of the scanning operations. In this manner, when the ON rates of the EL elements on each scan line, correction can be performed such that occurrence of shadowing caused when the ON rates are especially low is reduced.

In the configuration shown in FIG. 6, the drive device can be operated such that ON-drive data is calculated from the look-up table 14 by, in addition to the ON rate PN, data of dimmer control. According to this case, depending on ON rates of EL elements every scanning operation and dimmer control data set at this time, ON-drive data read from the look-up table 14 is supplied to the data driver 2.

FIGS. 7A to 7D2 explain a control mode which suppresses occurrence of shadowing by the configuration shown in FIG. 6. FIGS. 7A and 7B show the scanning synchronous signal explained with reference to FIG. 2 and a rest period synchronized with the scanning synchronous signal. FIG. 7C explains a drive operation of the EL element in a constant current drive period subsequent to the reset period. The abscissa in FIG. 7C shows a light-emitting drive current value I of the EL element. FIG. 7C explains a control mode according a first aspect of the present invention.

In the control mode shown in FIG. 7C, on the basis of the ON rate PN of the EL elements every scanning operation, a light-emitting drive current value supplied to EL elements to be controlled to emit light is controlled. In the control mode, an operation is executed such that a light-emitting luminance is increased as indicated as “Up” or decreased as indicated as “Dn” on the basis of the ON-drive data stored in the look-up table 14 in advance depending on the degree of occurrence of the “bright shadowing” or the “dark shadowing”. In this manner, as described above, shadowing which can conspicuously occur in a state of, especially, a low ON rate can be effectively suppressed.

FIGS. 7D1 and 7D2 explain a control mode similarly performed by the configuration shown in FIG. 6. FIG. 7D1 shows an aspect in a high dimmer state, and FIG. 7D2 shows an aspect in a low dimmer state. FIGS. 7D1 and D2 show a control mode in which the degree of occurrence of shadowing is reduced by using, in addition to the ON rate PN, data of dimmer control. This explains a control mode according to a fourth aspect of the present invention.

As shown in FIG. 7D1, since shadowing rarely occurs in a high dimmer state as described above, constant-current drive is executed without specially correcting the ON-drive data calculated from the look-up table 14 as described above. On the other hand, in a low dimmer state, on the basis of the ON rate PN of EL elements in each scanning operation and the dimmer control data, the value of a light-emitting drive current supplied to an EL element to be controlled to emit light is controlled.

In this case, as shown in FIG. 7D2, as indicated as “Up” on the basis of the ON-drive data stored in the look-up table 14 in advance, or as indicated as “Dn”, an operation of increasing or decreasing the luminance with reference to the original light-emitting luminance. In this manner, as described above, shadowing in, especially a low dimmer state can be effectively suppressed from occurring.

FIG. 8 shows the second embodiment to which the invention is applied with respect to a part especially corresponding to the data driver 2 shown in FIG. 1 and a part corresponding to the light-emission control circuit 4. In FIG. 8, the same reference numerals as in FIG. 6 denote the parts having the same functions as those of the constituent elements shown in FIG. 6 described above, and a description thereof will be omitted.

In the configuration shown in FIG. 8, a switch SC which alternatively selects ON-drive data read from the look-up table 14 replaced by the variable voltage source 21 or a control voltage Vcon set in advance is arranged, so that a luminance correction period or an ordinary constant current period is selected by the switch SC.

The switch SC is designed to execute a switching operation by a command from the drive control circuit 11. The constant current drive period shown in FIG. 7 described above is divided into two periods, i.e., a luminance correction period and an ordinary constant current period, so that a light-emitting drive operation of an EL element is executed. In the luminance correction period, the switch SC selects the variable voltage source 21. In the ordinary constant current period, the switch SC selects the control voltage Vcon.

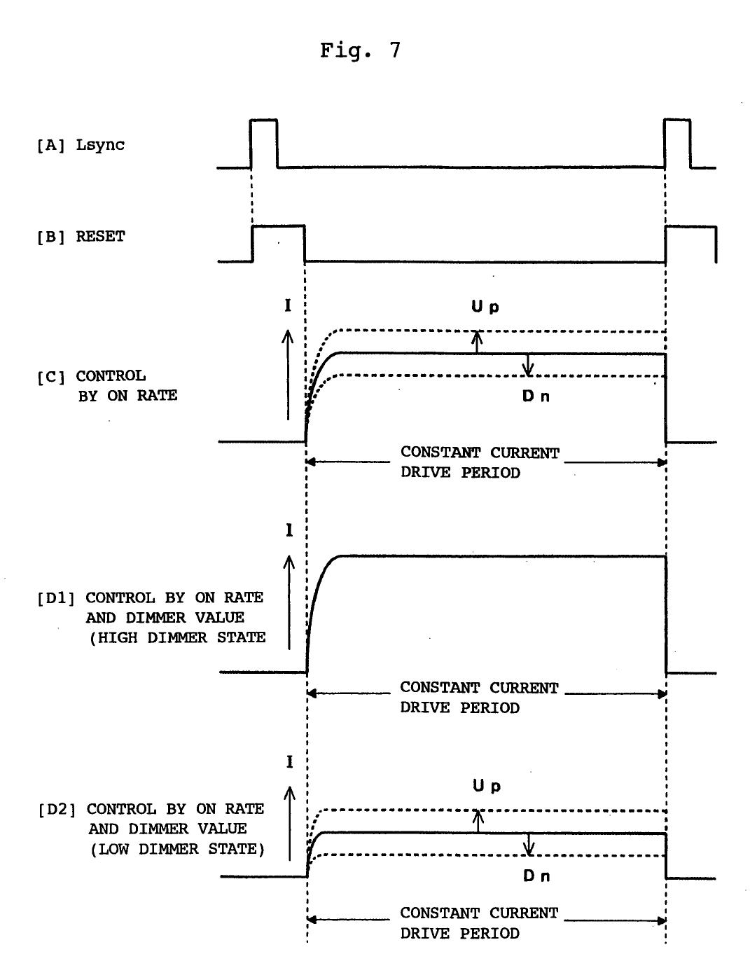

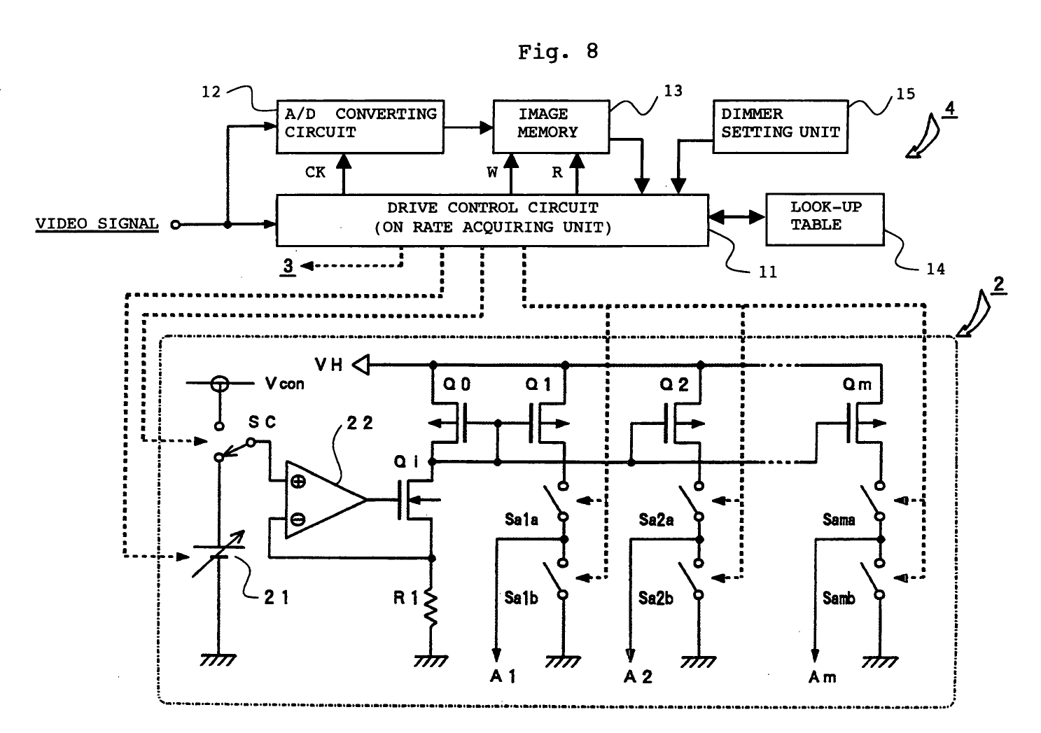

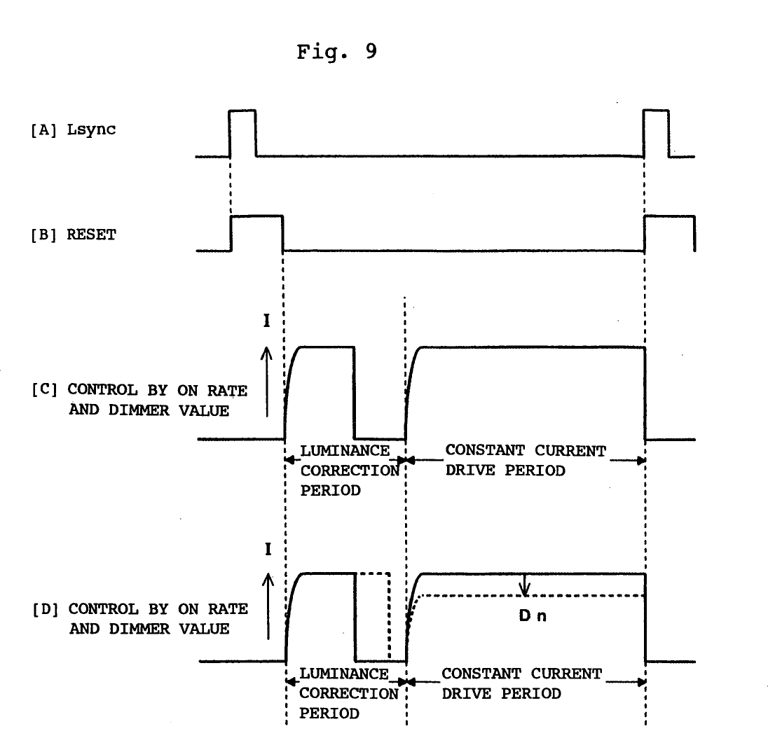

FIGS. 9A to 9D are to explain a control mode in which shadowing caused by the configuration shown in FIG. 8 is suppressed. FIGS. 9A and 9B show the scanning synchronous signal described with reference to FIG. 2 and a reset period synchronized with the scanning synchronous signal. In FIG. 9C, subsequent to the reset period, a luminance correction period and an ordinary constant current period are set, so that an EL element is driven to emit light in a total of the luminance correction period and the ordinary constant current period. FIG. 9C explains a control mode according to a second aspect of the present invention.

In the luminance correction period shown in FIG. 9C, on the basis of ON-drive data stored in the look-up table 14 on the basis of the ON rate PN of EL element in each scanning operation, a light-emitting drive current is supplied to an EL element to be controlled to emit light. That is, the switch SC shown in FIG. 8 is set in such a state that the variable voltage source 21 is selected. In the control mode shown in FIG. 9C, during the luminance correction period, control is performed such that the supply of the light-emitting drive current is stopped.

That is, time for supplying a light-emitting drive current is controlled in the luminance correction period. This is performed by performing switching operations for the analog switches Sa1a to Sama and Sa1b to Samb on the basis of the ON-drive data stored in the look-up table 14. Thereafter, the luminance correction period shift to the ordinary constant current period, and the switch SC selects the control voltage Vcon. Therefore, in the ordinary constant current period, a constant current on the basis of the control voltage Vcon is supplied as a light-emitting drive current to an EL element to be controlled to emit light.

Therefore, according to the control mode shown in FIG. 9C, on the basis of supply time of the light-emitting drive current set in the luminance correction period, the light emitting luminance of the EL element is corrected. In this manner, the shadowing can be effectively suppressed from occurring.

FIG. 9D is to explain a control mode obtained by the configuration shown in FIG. 8 as described above. FIG. 9D is to explain a control mode according to a third aspect of the present invention. That is, on the basis of the ON rate PN of EL elements in each scanning operation, in the luminance correction period, a supply period of a light-emitting drive current supplied to an EL element to be controlled to emit light is controlled. This is performed such that switching operations for the analog switches Sa1a to Sama and Sa1b to Samb are performed on the basis of the ON-drive data stored in the look-up table 14 as in the control mode shown in FIG. 9C.

Thereafter, the luminance correction period shifts to the ordinary constant current period. In the ordinary constant current period, a light-emitting drive current value of the EL element is controlled. When the light-emitting drive current in the ordinary constant current period is decreased as shown in FIG. 7D to suppress shadowing from occurring, control for decreasing the voltage Vcon shown in FIG. 8 is executed. Therefore, according to the control mode shown in FIG. 9D, on the basis of the supply time of the light-emitting drive current set in the luminance correction period and the light-emitting drive current value set in the ordinary constant current period, the light-emitting luminances of all the EL elements are corrected. In this manner, the shadowing can be effectively suppressed from occurring.

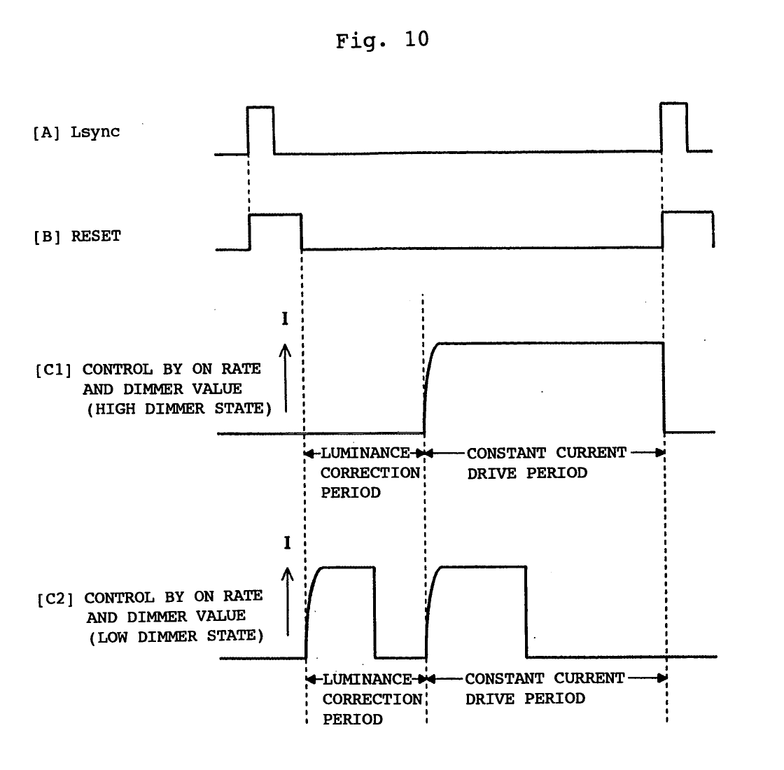

FIGS. 10A to 10C2 are to explain another control mode obtained by the configuration shown in FIG. 8 described above. FIGS. 10A and 10B show the scanning synchronous signal described with reference to FIG. 2 and a reset period synchronized with the scanning synchronous signal. FIG. 10C1 shows an aspect in a high dimmer state, and FIG. 10C2 shows an aspect in a low dimmer state. FIGS. 10C1 shows an aspect in a high dimmer state and 10C2 show an aspect in a low dimmer state a control aspect in which the degree of occurrence of shadowing is reduced by using, in addition to the ON rate PN described above, data of dimmer control. This explains a control mode according to a fifth aspect of the present invention.

As shown in FIG. 10C1, since shadowing rarely occurs in the high dimmer state, in the ordinary constant current period, a constant drive current is supplied to an EL element to be controlled to emit light is supplied by using the potential Vcon shown in FIG. 8.

On the other hand, as shown in FIG. 10C2, in the low dimmer state, a period to provide a light emitting drive current to an EL elements to be controlled to emit light in a luminance correction period and an ordinary constant current period is controlled.

This control is performed such that control operations of the analog switches Sa1a to Sama and Sa1b to Samb are performed as described above. Therefore, according to the control mode shown in FIGS. 10C1 and 10C2, supply time of the light-emitting drive current is controlled in the luminance correction period and the ordinary constant current period to correct the light-emitting luminances of all the EL elements. In this manner, the shadowing can be effectively suppressed from occurring.

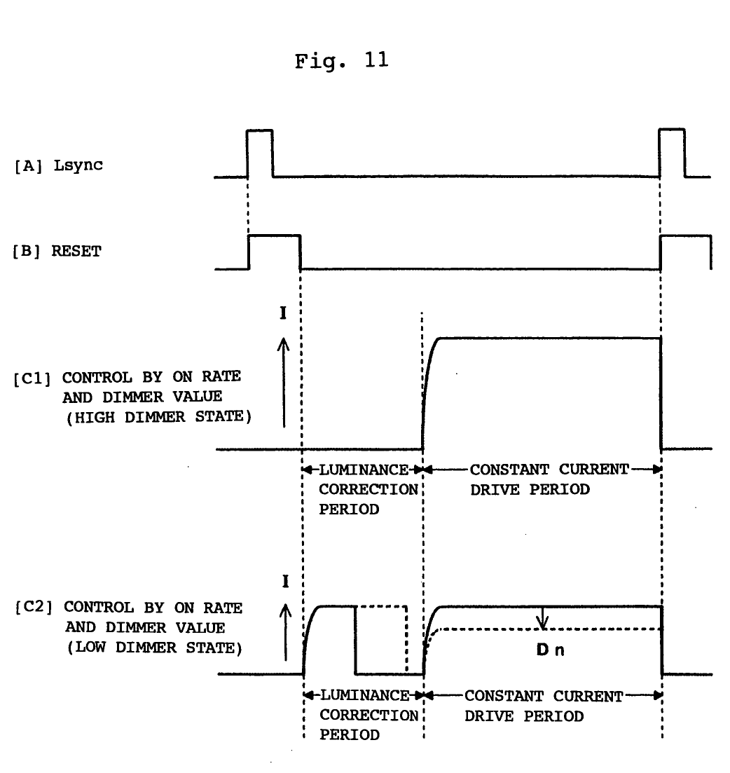

FIGS. 11A to 11C2 are to explain still another control mode obtained by the configuration shown in FIG. 8 described above. FIGS. 11A and 11B show a scanning synchronous signal described with reference to FIG. 2 and a reset period synchronized with the scanning synchronous signal. FIG. 11C1 shows an aspect in a high dimmer state, and FIG. 11C2 shows an aspect in a low dimmer state. FIGS. 11C1 and 11C2 show a control aspect in which the degree of occurrence of shadowing is reduced by using, in addition to the ON rate PN described above, data of dimmer control. This explains a control mode according to a sixth aspect of the present invention.

As shown in FIG. 11C1, since shadowing rarely occurs in a high dimmer state, in the ordinary constant current period, a constant drive current is supplied to the EL element to be controlled to emit light is supplied by using the voltage Vcon shown in FIG. 8.

On the other hand, in a low dimmer state, as shown in FIG. 11C2, in the luminance correction period and the ordinary constant current period, a mode in which a light-emitting drive current is supplied to an EL element to be controlled to emit light changes. That is, in the luminance correction period, a period for supplying the light-emitting drive current is controlled on the basis of the ON rate PN and the dimmer control data. This control is performed such that switching operations for the analog switches Sa1a to Sama and Sa1b to Samb are performed as described above.

In the ordinary constant current period, the light-emitting drive current is controlled on the basis of the ON rate PN and the dimmer control data. For example, when the light-emitting drive current in the ordinary constant current period is decreased as shown in FIG. 11C2 to suppress shadowing from occurring, control for decreasing the voltage Vcon shown in FIG. 8 is executed.

Therefore, according to the control mode shown in FIG. 11A to 11C2, on the basis of the supply time of the light-emitting drive current set in the luminance correction period and the light-emitting drive current value set in the ordinary constant current period, the light-emitting luminances of all the EL elements are corrected. In this manner, the shadowing can be effectively suppressed from occurring.

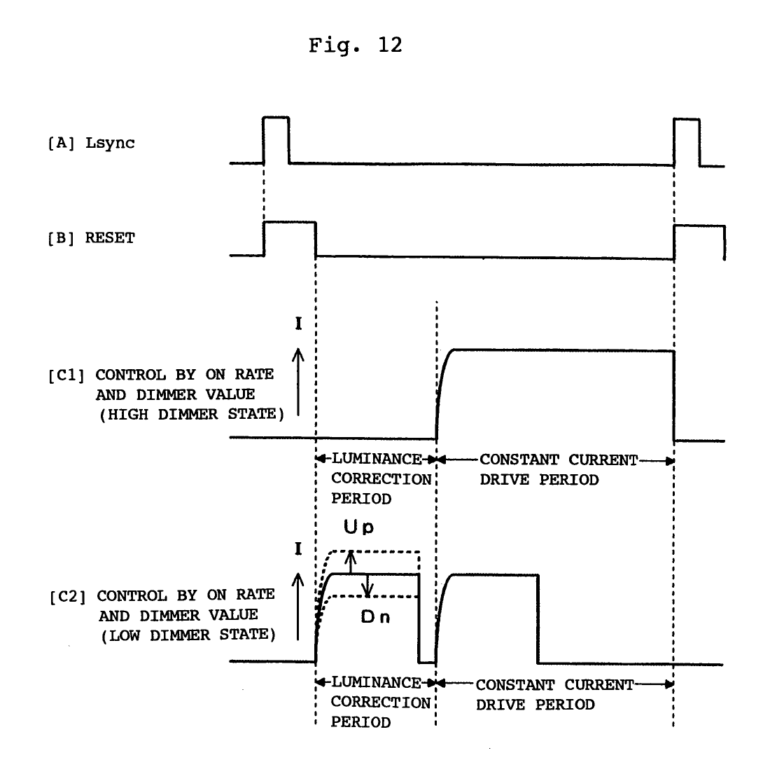

FIGS. 12A to 12C2 are to explain still another control mode obtained by the configuration shown in FIG. 8 described above. FIGS. 12A and 12B show the scanning synchronous signal described with reference to FIG. 2 and a reset period synchronized with the scanning synchronous signal. FIG. 12C1 shows an aspect in a high dimmer state, and FIG. 12C2 shows an aspect in a low dimmer state. FIGS. 12C1 and 12C2 show a control aspect in which the degree of occurrence of shadowing is reduced by using, in addition to the ON rate PN described above, data of dimmer control. FIGS. 12C1 and 12C2 are also to explain a control mode according to the sixth aspect of the present invention.

As shown in FIG. 12C1, since shadowing rarely occurs in a high dimmer state, in the ordinary constant current period, a constant drive current is supplied to an EL element to be controlled to emit light is supplied by using the voltage Vcon shown in FIG. 8.

On the other hand, in a low dimmer state, as shown in FIG. 12C2, in the luminance correction period and the ordinary constant current period, a mode in which a light-emitting drive current is supplied to an EL element to be controlled to emit light changes. That is, in the luminance correction period, the light-emitting drive current supplied to the EL element to be controlled to emit light on the basis of the ON rate PN and the dimmer control data. In this case, in the luminance correction period, as indicated as “Up” on the basis of the ON-drive data stored in the look-up table 14 in advance, or as indicated as “Dn”, an operation of increasing or decreasing the luminances of the EL elements is executed by controlling the light-emitting drive current value.

A period of supplying a light-emitting drive current to an EL element to be controlled to emit light is controlled in the ordinary constant current period. This control is performed such that switching operations for the analog switches Sa1a to Sama and Sa1b to Samb are performed. Therefore, according to the control mode shown in FIGS. 12C1 and 12C2, the light-emitting drive current value is controlled in the luminance correction period, and supply time of the light-emitting drive current in the ordinary constant current period is controlled, so that the light-emitting luminances of all the EL elements are corrected. In this manner, the shadowing can be effectively suppressed from occurring.

The above embodiments describe an example using organic EL elements as light-emitting elements arranged on a display panel. Even though other capacitive elements are used as the light-emitting elements, the same operational effect as described above can be obtained. In the embodiments, on the basis of an ON rate of EL elements and dimmer control data, ON-drive data is read from a look-up table. However, the ON-drive data may be calculated by a logical operation.

1. A driving device for a light-emitting display panel to drive a passive matrix light-emitting display panel having a plurality of scan lines and a plurality of data lines which cross each other, and light-emitting elements connected between the scan lines and the data lines at crossing points of the scan lines and the data lines to emit light, comprising:
an ON rate acquiring unit which obtains a rate PN of light-emitting elements to be controlled to emit light in the light-emitting elements connected to the scan lines N (N=1 to n), and wherein,
on the basis of the rate PN obtained by the ON rate acquiring unit, a value of a light-emitting drive current supplied to the light-emitting elements to be controlled to emit light, the light-emitting elements being connected to the scan lines N, is controlled.

2. A driving device for a light-emitting display panel to drive a passive matrix light-emitting display panel having a plurality of scan lines and a plurality of data lines which cross each other, and light-emitting elements connected between the scan lines and the data lines at crossing points of the scan lines and the data lines to emit light, comprising:
an ON rate acquiring unit which obtains a rate PN of light-emitting elements to be controlled to emit light in the light emitting elements connected to the scan lines N (N=1 to n), and wherein,
on the basis of the rate PN obtained by the ON rate acquiring unit, a period for supplying a light emitting drive current supplied to the light-emitting elements to be controlled to emit light, the light-emitting elements being connected to the scan lines N, is controlled.

3. A driving device for a light-emitting display panel to drive a passive matrix light-emitting display panel having a plurality of scan lines and a plurality of data lines which cross each other, and light-emitting elements connected between the scan lines and the data lines at crossing points of the scan lines and the data lines to emit light, comprising:
an ON rate acquiring unit which obtains a rate PN of light-emitting elements to be controlled to emit light in the light emitting elements connected to the scan lines N (N=1 to n), and wherein
on the basis of the rate PN obtained by the ON rate acquiring unit, a period for supplying a light-emitting drive current and a value of a light-emitting drive current supplied to the light-emitting elements to be controlled to emit light, the light-emitting elements being connected to the scan lines N, is controlled.

4. A driving device for a light-emitting display panel to drive a passive matrix light-emitting display panel having a plurality of scan lines and a plurality of data lines which cross each other, and light-emitting elements connected between the scan lines and the data lines at crossing points of the scan lines and the data lines to emit light, comprising:
an ON rate acquiring unit which obtains a rate PN of light-emitting elements to be controlled to emit light in the light emitting elements connected to the scan lines N (N=1 to n); and a dimmer control unit which performs dimmer display of the dis9play panel in D (D=1 to d) steps, and wherein
on the basis of the rate PN obtained by the ON rate acquiring unit and the steps D of dimmer control in the dimmer control unit, a value of a light-emitting drive current supplied to the light-emitting element to be controlled to emit light, the light-emitting element being connected to the scan lines N, is controlled.

5. A driving device for a light-emitting display panel to drive a passive matrix light-emitting display panel having a plurality of scan lines and a plurality of data lines which cross each other, and light-emitting elements connected between the scan lines and the data lines at crossing points of the scan lines and the data lines to emit light, comprising:
an ON rate acquiring unit which obtains a rate PN of light-emitting elements to be controlled to emit light in the light emitting elements connected to the scan lines N (N=1 to n); and a dimmer control unit which performs dimmer display of the display panel in D (D=1 to d) steps, and wherein
on the basis of the rate PN obtained by the ON rate acquiring unit and the steps D of dimmer control in the dimmer control unit, a period for supplying a light-emitting drive current to the light-emitting element to be controlled to emit light, the light-emitting element being connected to the scan lines N, is controlled.

6. A driving device for a light-emitting display panel to drive a passive matrix light-emitting display panel having a plurality of scan lines and a plurality of data lines which cross each other, and light-emitting elements connected between the scan lines and the data lines at crossing points of the scan lines and the data lines to emit light, comprising:
an ON rate acquiring unit which obtains a rate PN of light-emitting elements to be controlled to emit light in the light emitting elements connected to the scan lines N (N=1 to n); and a dimmer control unit which performs dimmer display of the display panel in D (D=1 to d) steps, and wherein
on the basis of the rate PN obtained by the ON rate acquiring unit and the steps D of dimmer control in the dimmer control unit, a period for supplying a light emitting drive current and a value of a light-emitting drive current supplied to the light-emitting elements to be controlled to emit light, the light-emitting elements being connected to the scan lines N, is controlled.

7. The driving device for a light-emitting display panel according to any one of claims 1, 3, 4, or 6, wherein control of a light-emitting current value supplied to the light-emitting element is executed by current supply means constituted by a current mirror circuit, and a reference current value in the current mirror circuit is controlled to control the light-emitting drive current value.

8. The drive device for a light-emitting display panel according to any one of claims 2, 3, 5, or 6, wherein a luminance correction period for correcting a light emitting luminance of the light-emitting elements connected to the respective scanning lines N is set in each scanning period in which the scanning lines N are scanned.

9. The drive device for a light-emitting display panel according to any one of claims 1 to 6, wherein the light-emitting element is organic EL light-emitting element having an organic light-emitting function layer constituted by at least one layer between opposing electrodes.
